(19) United States
(12) Patent Application Publication
(10) Pub. No.: US 2022/0366755 A1
(43) Pub. Date: Nov. 17, 2022

(54) RECONFIGURABLE VENDING MACHINE AND A SYSTEM AND METHOD FOR MANAGING VENDING MACHINES

(71) Applicant: repointer labs Inc., Toronto (CA)

(72) Inventor: Gvarami LABARTKAVA, Toronto (CA)

(21) Appl. No.: 17/746,634

(22) Filed: May 17, 2022

Related U.S. Application Data
(60) Provisional application No. 63/189,267, filed on May 17, 2021.

(51) Int. Cl. G07F 9/00; G07F 9/02

(52) U.S. Cl. CPC G07F 9/006; G07F 9/002; G07F 9/026

(57) ABSTRACT

A reconfigurable vending machine is provided that allows two or more vendors to share certain common infrastructure such as a support structure for housing vending units and a controller for controlling the vending units. Each vending unit is configured to store salable items and is associated with a vendor. The vending units may be removable from the vending machine and may be operable independently from the common infrastructure. Furthermore, the vending unit can be modular with at least one removable module for storing salable items. A method and system for managing inventory and sales in a reconfigurable vending machine is further provided.

### FIELD

The present specification is directed to vending machines, and more particularly, to a reconfigurable vending machine having modular elements and a system for managing vending machines.

### BACKGROUND

Vending machines provide an automated mechanism for sellers to offer goods for sale to consumers, thereby permitting the sale of goods in the absence of a cashier and at any time of the day or night. In contrast to brick-and-mortar store fronts, vending machines provide a great deal of flexibility in location. Vending machines may be placed indoors or outdoors, and a greater number of locations than a brick-and-mortar shop. Whereas a single storefront may service several neighborhoods, forcing consumers to travel a great distance to purchase goods, vending machines may be dispersed throughout neighborhoods in locations that are closer to the consumer.

Despite their numerous advantages, vending machines are typically only used for the sale of convenience foods which have low value but a high sales volume. One of the principal reasons for this is the significant investment of resources required to install and maintain a vending machine. While a vending machine itself can cost upwards of $10,000 USD, vendors can also expect to pay for the cost of the payment terminal. Additionally, a vendor must account for rental fees paid to the property owner, restocking services, and repair services. And although it is possible to move a vending machine to a new location, the weight of the machine and the inconvenience of arranging rental agreements are considerable barriers to relocation.

### SUMMARY

It is an aspect of the present invention to provide a reconfigurable vending machine. The reconfigurable vending machine has a controller and at least one vending unit for storing salable items. The controller generates a data record representing at least one salable item and transmits the data record over a network.

It is a further aspect of the present disclosure to provide a system for managing reconfigurable vending machines. The above aspects can be attained by one or more vending machines that have at least one vending unit for storing salable items. The vending machines also have a computing device for generating data records representing the items and then transmitting those data records to a server.

It is a yet further aspect of the present invention to provide a method for managing a reconfigurable vending machine. The vending machine has a controller and at least one removable vending unit for storing salable items. First, the controller receives an input signal representing a salable item, generates a data record based on the input signal, and transmits the data record to a server. Then, the server receives the data record and stores the data record in memory. In response to a request from a computing device, the server transmits the data record to the computing device.

It is an aspect of the present invention to provide a multi-vendor functionality and operation of a vending machine. The vending machine has one or more vending units and a shared controller. Each vending unit may be managed by a separate vendor, but the vendors may use the same machine and the machines are connected to the same controller. The vending unit may be associated with a vendor identifier.

It is an aspect of the present invention to provide a method of vending unit detection in a vending machine and relocation method of the vending unit or module from a different vending machine. Each vending machine may have a number of spaces available for the vending units. The vendor may choose the vending machine which is preferable for them based on locations or other factors and install their vending unit in said vending machine. The vending machine may auto detect the vending unit's configuration and information when the vending unit is installed and send the data to the network. The vendor may relocate the vending unit by authorizing the vending machine to unlock said vending unit and installing the vending unit in a different vending machine.

It is an aspect of the present invention to provide a modular vending unit. A vending unit, which is configured to be installed in a reconfigurable vending machine, may have one or more removable modules for storing salable items. Each module may have one or more removable dividers which separate goods. The vending machine may have accessories which add different functionalities in the machine. The modular functionality of the vending machine allows vendors to customize machines by their needs while using the shared machine structure and controller with other vendors.

It is an aspect of the present disclosure to provide a system for managing a plurality of vending machines which have removable vending units that can moved from one vending machine to another vending machine. In this system, each vending machine is associated with a machine identifier that is unique to that vending machine. The vending units store salable items. A server is configured to store data records pertaining to each of the vending units. When data pertaining to a vending unit needs to be updated, a controller obtains the machine identifier where the vending unit is located as well as a unit identifier uniquely associated with the vending unit. The controller transmits the unit identifier and the machine identifier over a network to the server. In response to receiving the unit identifier and machine identifier, the server retrieves a data record associated with the unit identifier and updates the data record.

In some examples, the controller is integrated in the vending machine and the machine identifier is stored in memory at the controller.

In some examples, the controller is remote from the vending machine. The controller is configured to receive an input representing the machine identifier.

In some examples, the controller is integrated in a computing device.

In some examples, the system also includes a computing device that requests the data record from the server. In response to the request, the server transmits the data record to the computing device.

In some examples, the vending unit a unit sensor that detects a barcode on the vending machine. The barcode represents the unit identifier. In response to detecting the barcode, the unit sensor sends a signal to the controller that includes the unit identifier.

In some examples, the unit sensor can detect when a vending unit has been removed from a vending machine. In response to detecting the removal, the unit sensor sends a removal signal to the controller that includes the unit identifier.

In some examples, the vending machine includes a product sensor to detect salable items in a vending unit. In response to detecting a salable item, the product sensor sends a signal to the controller which includes an item identifier associated with the salable item.

In some examples, the data record stores information about the vending unit including vendor and product information. In particular, the data record may include a vendor identifier representing a vendor associated with the vending unit, an item identifier representing the salable item, a quantity of the salable item, a quality of the salable item, and a price of the salable item.

In some examples, the data record includes location information indicating the location of the vending unit. When the computing device receives the data record from the server, the computing device displays the location of the vending unit. For example, the location of the vending unit may be displayed on a map shown at the computing device.

It is a further aspect of the present disclosure to provide a method for managing vending machines which have removable vending units that can be moved from one vending machine to another vending machine. The vending units are for storing salable items. A controller obtains a machine identifier uniquely associated with one of the vending machine and a unit identifier uniquely associated with one of the vending units. Next, the controller transmits the unit identifier and machine identifier to a server via a network. In response to the transmission, the server retrieves a data record from its memory which includes the unit identifier. The data record includes information about the vending unit. After retrieving the data record, the server updates the data record based on the machine identifier received from the controller.

In some examples, the server transmits the data record to a computing device in response to a request from the computing device.

In some examples, the vending machine uses a unit sensor to detect a barcode on the vending unit which indicates the unit identifier for that vending unit. In response to detecting the barcode, the unit sensor transmits a signal to the controller which includes the unit sensor.

In some examples, the unit sensor detects when a vending unit has been removed from the vending machine and signals the controller with a removal signal that includes the unit identifier for the removed vending unit.

In some examples, when a vending unit is relocated from a first vending machine to a second vending machine, the controller obtains the unit identifier for the vending unit and the machine identifier for the second vending machine. The controller transmits the unit identifier and the machine identifier to the server which updates the data record associated with the unit identifier.

In some examples, the controller obtains a unit identifier, an item identifier associated with a salable item, and a status signal indicating whether the salable item has been added or removed from the vending unit. Next, the controller transmits the item identifier, status signal, and unit identifier to the server which retrieves the data record associated with the unit identifier. The server updates the data record to increment or decrement the quantity of the salable item stored in the vending unit, according to the status signal.

In some examples, the data record includes vendor and product information such as a vendor identifier representing a vendor associated with the vending unit, an item identifier representing the salable item, a quantity of the salable item, a quality of the salable item, and a price of the salable item.

In some examples, the data record includes location information indicating the location of the vending unit. When the computing device receives the data record from the server, the computing device displays the location of the vending unit. For example, the location of the vending unit may be displayed on a map shown at the computing device.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a system diagram showing a system for managing reconfigurable vending machines.

FIG. 2 is a perspective view of an embodiment of the module of FIG. 1.

FIG. 3 is a perspective view of the module of FIG. 2.

FIG. 4 is a perspective view of the module of FIG. 2.

FIG. 5 is a perspective view of an embodiment of the divider of FIG. 2.

FIG. 6 is a perspective view of a vending unit comprising the modules of FIG. 2.

FIG. 7A is a perspective view of an embodiment of the module of FIG. 1.

FIG. 7B is a perspective view of the module of FIG. 7A.

FIG. 7C is a perspective view of the module of FIG. 7A.

FIG. 8A is a top view of another embodiment of the module of FIG. 1.

FIG. 8B is a perspective view of the module of FIG. 8A.

FIG. 8C is a bottom view of the module of FIG. 8A.

FIG. 9 is an embodiment of the vending machine of FIG. 1.

FIG. 10 is another embodiment of the vending machine of FIG. 1.

FIG. 11 is a flowchart depicting a method for managing modular vending machines in accordance with another embodiment

FIG. 12 is a drawing depicting a user interface in exemplary performance of block 1128 from the method of FIG. 11.

FIG. 13 is a flowchart depicting a method of registering items in accordance with another embodiment.

FIG. 14 is a top view of another vending machine.

FIG. 15 is a perspective view of the vending machine of FIG. 14.

### DETAILED DESCRIPTION

The present disclosure pertains to a system and method for managing reconfigurable vending machines comprising one or more vending units. Furthermore, it contains modularized and customizable vending units inside the reconfigurable machine. A centralized controller transmits data records associated with salable items stored in the units to a server which stores the data records in memory.

There are multiple advantages of the vending machine and the system and method for managing vending machines. Multiple vendors, especially small business owners and startups, may buy their own vending units at a lower cost, than if they were to purchase a traditional vending machine. Vendors can customize the vending units based on their needs and operate the vending unit autonomously or semi-autonomously from the vending machine as a whole. A reconfigurable machine allows vendors to share a common controller which may include one or more payment systems, card readers, scanners, and other peripheral devices, which leads to reduced price of the vending unit itself. Moreover, this configuration allows vendors to choose the location of the machine based on their preferences or even relocate or temporarily remove a vending unit from operation. These advantages together provide a convenient way for vendors to operate their own vending units independently from other vendors using the same vending machine. The vending unit may comprise an internal motor and a controller which allow the vendor to operate the unit remotely.

The methods, functionality, and other techniques discussed herein may be carried out by instructions, which may be directly executable (e.g., a binary file), indirectly executable (e.g., bytecode), interpreted (e.g., a script), or otherwise executable by a processor. Instructions may be stored in a non-transitory computer-readable medium, such as a memory, hard drive, or similar device.

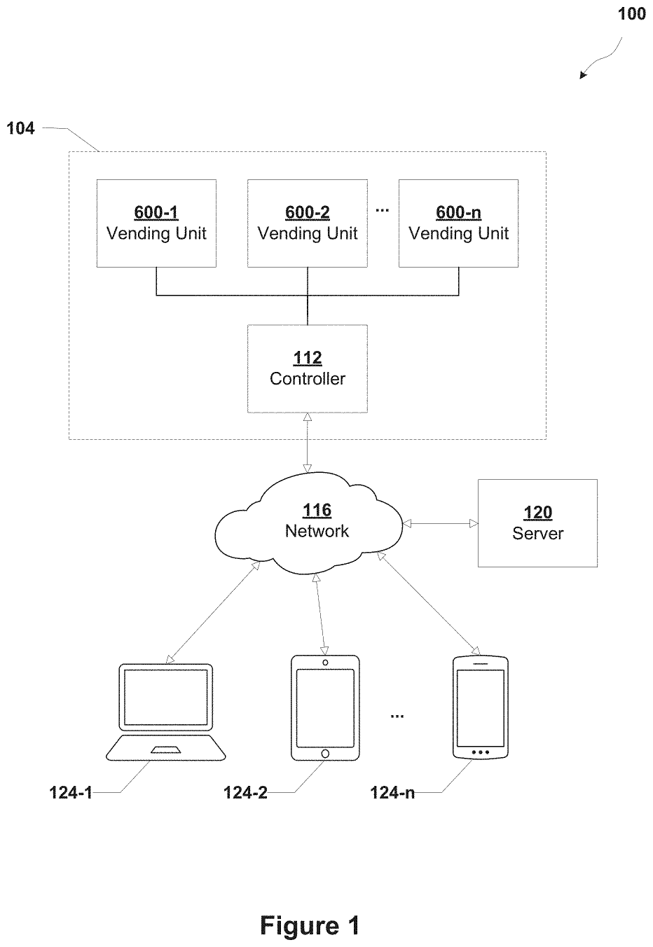

Referring now to FIG. 1, a system for managing reconfigurable vending machines is indicated generally at 100. System 100 comprises at least one vending machine 104 (generically referred to herein as “vending machine 104” or collectively as “vending machines 104”). The vending machine 104 comprises a plurality of vending units 600-1, 600-2 . . . 600-n (generically referred to herein as “vending unit 600” or collectively as “vending units 600”) and a controller 112. The vending machine 104 is connected to the network 116 which is further connected to a server 120 and a plurality of computing devices 124-1, 124-2 . . . 124-n (generically referred to herein as “computing device 124” or collectively as “computing devices 124”).

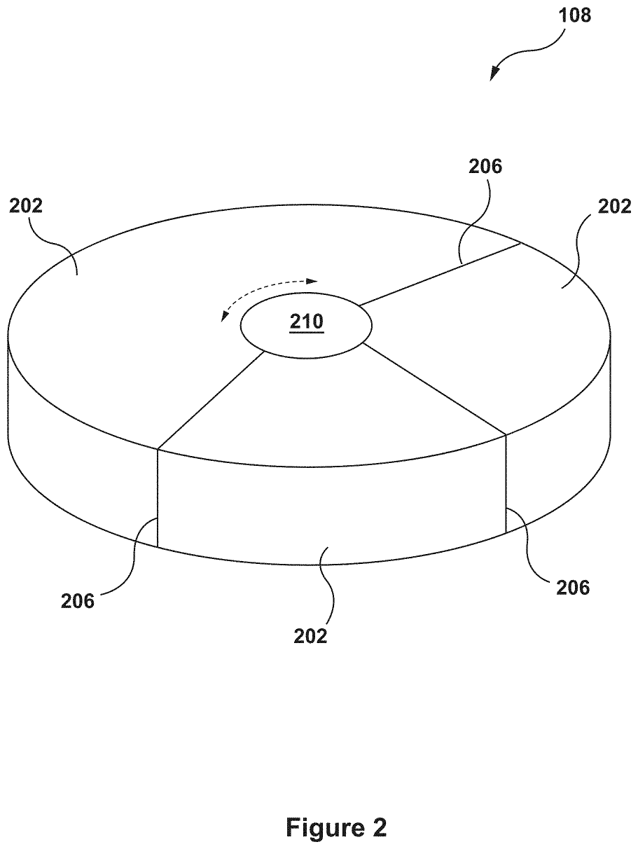

The vending units 600 are configured to contain one or more items for sale. Each vending unit 600 is associated with a vendor. In implementations described herein, the vending units 600 are subdivided into one or more modules 108 (as seen in FIGS. 2 to 6), however the vending units 600 are not particularly limited. Note that in other implementations, the vending unit 600 may be fixed rather than modular. The modules 108 are compartments for containing one or more items for sale. In order for the consumer to view the item(s), the module 108 may include at least one transparent surface. The modules 108 may be subdivided into sectors to separate the one or more items for sale. In order for the consumer to access an item after purchasing said item, the module 108 may be enclosed and may include an access mechanism (not shown) having an open position and a closed position such that, when the access mechanism is in an open position, a user may access one or more items in the module 108. The module 108 may comprise an internal controller for performing computational operations such as transmitting data to other components of the module 108, receiving data from components of the module 108, sending control signals to components of the module 108, transmitting data to the controller 112, receiving data from the controller 112, and receiving control signals from the controllers 112. The access mechanism may be controlled by the controller 112 in response to an input received at the controller 112. Each vending machine 104 may be configured to house a plurality of vending units 600. The vending units may be removably attached to the vending machine 104. The vending machine 104 may be circular, L-shape, T-shape, Z-shape or any suitable shape and can be distributed on a suitable surface. The vending machine 104 may further comprise a support structure such as a rack or chassis for supporting the vending units 600. The vending units 600 may be stackable. The vending unit 600 are not constrained to a particular shape or size, however it may be advantageous for the vending unit 600 to be shaped and sized to accommodate the items for sale. In some implementations, the vending unit 600 is substantially shaped like a rectangular prism and in other implementations the vending unit 600 is substantially shaped like a cylinder. It is not necessary for all the vending units 600 to be the same size or shape, although in some implementations, the vending units 600 have the same size and shape. Additionally, one or more vending units 600 may be customized with optical and audio elements, which are controlled by the controller 112 or base 606. The modules 108 are connected to the base 606 which form vending unit 600 which is connected to a controller 112.

The controller 112 is typically a computing device for managing the vending machine 104. The controller 112 is connected to the server 120 via the network 116. In the example shown in FIG. 1, the controller 112 is integrated in the vending machine 104, however in other examples, the controller may be remote from the vending machine 104. In examples where the controller 112 is remote from the vending machine 104, the controller 112 may be a smartphone, personal computer, tablet, wearable devices, smart home systems, or the like. The controller 112 may comprise a user interface for receiving inputs. The controller 112 may further comprise a processor for generating data records representing items. The controller 112 may also comprise a memory for storing the data records and a network interface for transmitting data to the server 120 via the network 116. The controller 112 may be connectable to the network using CoAP, HTTP, HTTPs, RestAPI, or any suitable network protocol. The controller 112 may further comprise a payment terminal configured to process coins, bills, electronic payments (i.e. credit cards, debit cards, gift cards, prepaid cards, or cryptocurrency) or a combination thereof. In examples that include a payment terminal for processing electronic payments, the controller 112 is configured to process payment requests and transmit the payment requests to a payment provider via the network 116. In some implementations, the controller 112 may include a printer for printing receipts. In yet other implementations, the controller 112 may include a barcode/QR code scanner. In one implementation, the controller 112 may comprise at least one internal controller associated with the module 108 and at least one internal controller associated with the base 606.

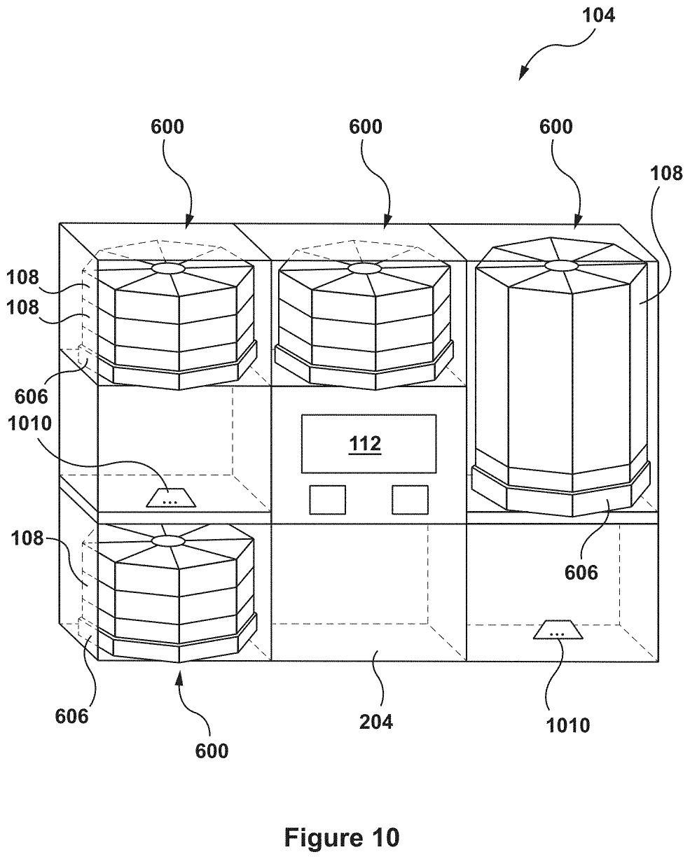

A connector 1010 (as seen in FIG. 10) may attach to the vending unit 600 through the base 606. The connector 1010 may comprise a serial interface which transfers and receives data from a controller 112. Additionally, the connector 1010 may comprise an internal lock which can lock the vending unit 600 to the base 606. The connector 1010 may supply power to the vending unit 600. The controller 112 may detect the presence of the vending unit 600 through connector 1010 and activate the lock. The controller 112 may be able to communicate to the vending unit 600 with the internal controller of base 606 either through connector 1010 or using the wireless capability of controller of base 606.

The network 116 can be wired or wireless, or based on combinations thereof, and based on any type of known network architecture or platform (e.g. the Internet or a wide area network) or combinations thereof. Generally, network 116 provides an infrastructure to interconnect the server 120, the vending machines 104, and the computing devices 124. Moreover the network may communicate with the internal controller of base 606 using the wireless capability of controller of base 606.

The server 120 is typically a server or mainframe with a housing containing an arrangement of one or more central processing units, volatile memory (i.e. random-access memory), persistent memory (i.e. hard disk devices) and a network interface (to allow the server 120 to communicate over the network 116) all of which are interconnected by a bus. In some embodiments, the server 120 is a virtual server. As explained in detail below, the server 120 is configured to receive data records from the network 116 and forward data records to the computing devices 124 via the network 116. The server 120 is further configured to store data records in memory. Each data record may include a machine identifier representing one of the vending machines 104 and one or more unit identifiers representing each vending unit installed at said vending machine 104. The server 120 may further store in memory item data representing a salable item, and the item data may be stored in association with a unit identifier representing the vending unit where the salable item is stored. If the item data is stored separately from the machine identifiers, updating data at the server 120 can be simplified. Data records for the vending machines 104 can be updated periodically with new unit identifiers when vending units are transferred from one vending machine 104 to another vending machine 103 without needing to update the item data. Thus, networking and computing resources are conserved when a vending unit is relocated.

The computing devices 124 can be personal computers, smartphones, tablets, wearable devices, smart home systems, or the like, and are configured to receive information from the server 120 via the network 116. Each computing device 124 may be associated with a vendor, a consumer, or the system owner. In some implementations, the computing devices 124 are further configured to transmit information to the server 120 via the network 116.

Specific configurations and implementations of the vending machine 104 are shown in FIGS. 2 to 10.

FIG. 2 shows a diagram of one implementation of the module 108 that is subdivided into compartments 202 for containing salable items. In this implementation, the module is depicted as being cylindrical, but the module 108 is not necessarily restricted to that shape. In other examples, the module 108 is a polygonal prism, a cube, a rectangular prism, or the like. The compartments 202 are separated with dividers 206 which separate the module 108 into compartments 202. In the implementation shown in FIG. 2, the dividers 206 are configured to subdivide the module 108 radially, however in other implementations the module 108 may be subdivided longitudinally. It is also contemplated that the dividers 206 may separate the module 108 horizontally rather than vertically, as shown in FIG. 2. The dividers 206 may be configured to restrict access to one or more compartments 202. The implementation shown also depicts a support structure 210 which may be configured to attach two modules 108. The support structure 210 may be substantially hollow and configured to house electrical connectors for transmitting electrical communications between the modules 108. The support structure 210 may be further configured to house a motor for rotating the module 108.

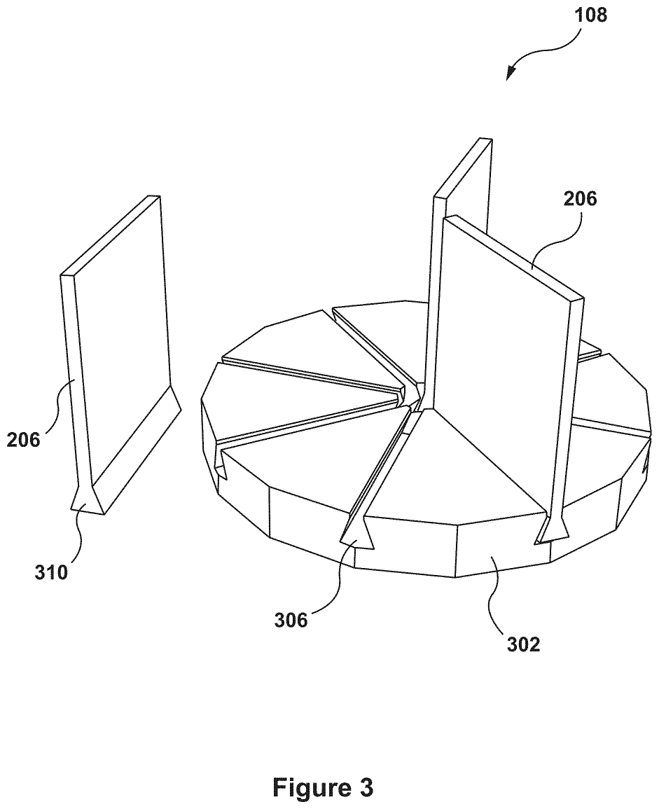

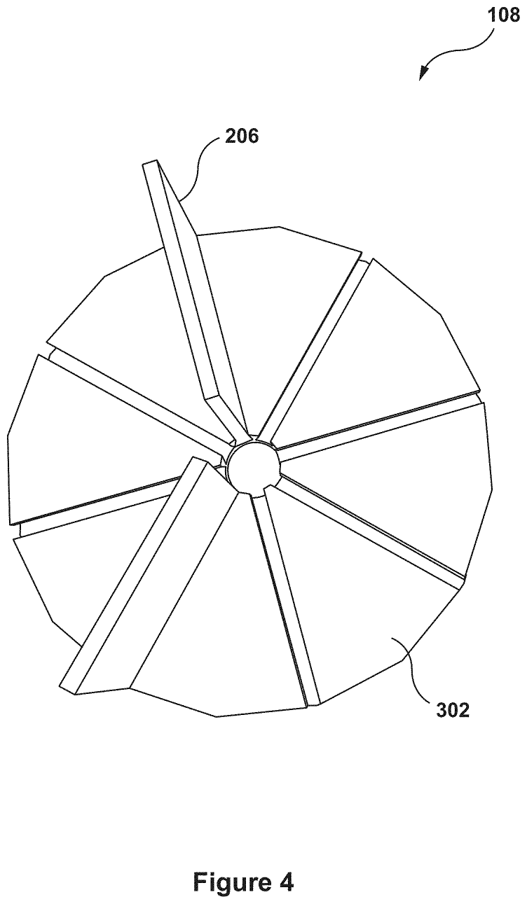

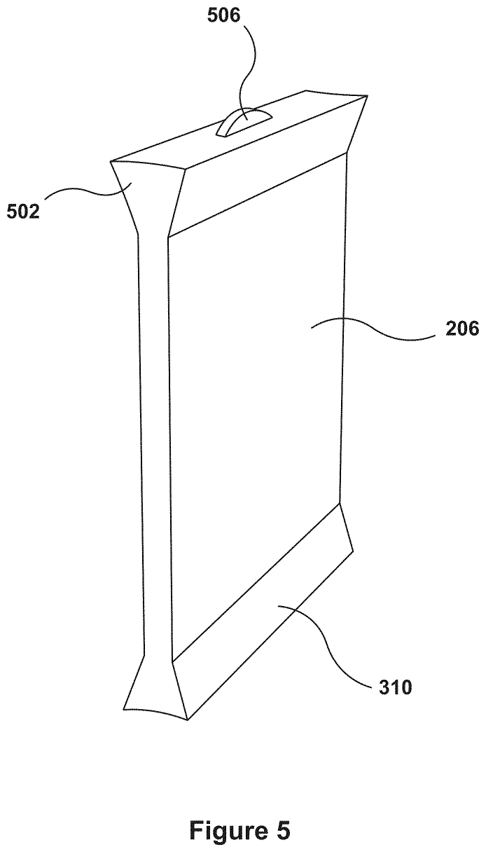

FIGS. 3 and 4 show another implementation of the module 108. In this implementation, the module 108 has a platform 302 for supporting the items. Two dividers 206 separate the module 108 into two compartments. In this implementation, the dividers 206 are removably attached to the platform 302 such that the number and size of the compartments may be modified. A number of attachment mechanisms are contemplated including fasteners, magnets, snap and lock mechanisms, tongue and groove mechanisms, and interlocking mechanisms. In the implementation shown, the platform 302 comprises one or more slots 306 that are configured to receive the divider 206. The divider 206 is flared at a bottom end 310 which is complementary to a slot 306 on an upper surface of the platform 302. Although not depicted here, the platform 302 may further include one or more slots on a bottom surface of the platform. When a first module 108 is stacked on top of a second module 108, the dividers 206 may attach to the upper surface of the second module 108 and the lower surface of the first module 108. The divider 206 shown in FIG. 5 is configured to attach to a first and second module 108 in this way. The divider 206 has a top end 502 and a bottom end 310 configured to be received by the slots on a platform 302. The divider 206 may further include a connector 506 for transmitting data between adjacent modules 108 and for detecting the arrangement of the dividers. The platform 302 may have one or more complementary connectors such that, when the divider 206 is attached to the platform 302, the connector 506 on the divider 206 is in communication with the corresponding complimentary connector on the platform 302. When the divider 206 is connected to the platform 302, the connection may cause a signal to be sent to the controller 112 indicating the location of the divider 206. This possible mechanism allows vendors to easily self-assemble and customize vending machines. In some implementations, the module 108 may further comprise one or more electrical connectors for transmitting data between adjacent modules 108. When one or more modules 108 are connected, the respective electrical connectors are in communication.

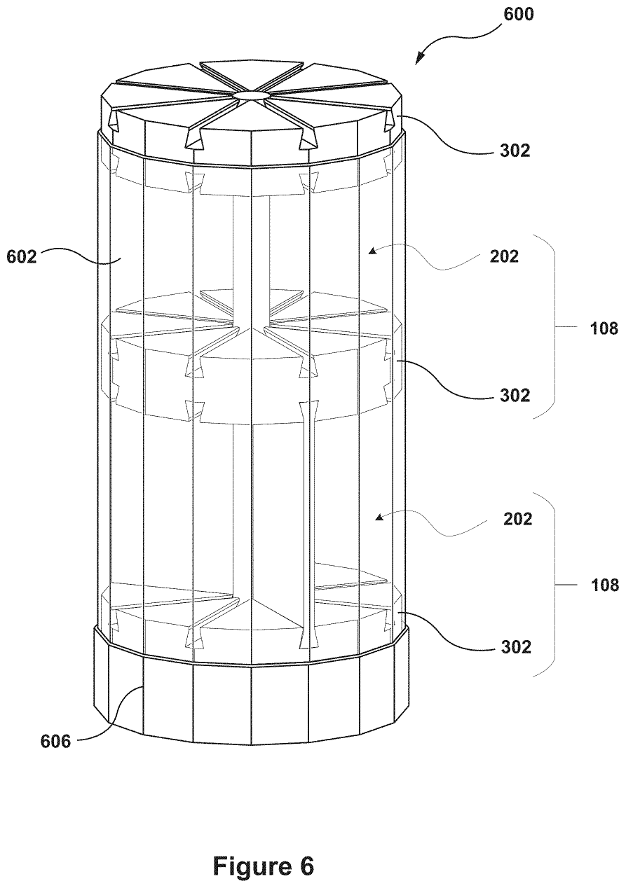

As described above, two or more modules 108 may be combined to form a vending unit. One implementation of a vending unit is shown in FIG. 6 at 600. FIG. 6 shows a vending unit 600 comprising two modules 108, however, a vending unit 600 may comprise any suitable number of modules 108 or even just present a fixed non-modular vending unit with or without the base. In this implementation, the vending unit 600 comprises an enclosure 602 for restricting access to the items stored in the modules 108. The enclosure may be transparent or translucent to allow the user to view the salable items before purchase. Suitable examples of materials for the enclosure 602 may include glass and polymers such as acrylic, polycarbonate. The vending unit 600 further comprises a base 606 for supporting the modules 108 and controlling using an internal controller separate from controller 112. The base 606 may be fixed, while the modules 108 may be capable of rotating, as described above.

The base 606 may further comprise a motor for rotating the vending machine. The base 606 may comprise an internal computing device for controlling the motor, receiving and transferring information to the modules 108 and communicating to computing device 124 using short-range wireless technology or controller 112 via serial interface. Furthermore a base 606 may use the internal computing device to communicate with the modules 108. By communicating with the modules 108, the base may receive data representing the current configuration, inventory, and purchase events. The base 606 may further transmit this data to the computing device 124 such that the vendor can retrieve the data through a mobile app. Moreover this may allow the vending unit 600 to function independently from the vending machine 104, since the internal controller in the base 606 can be used as a replacement for the controller 112. Base 606 may communicate with modules 108 using serial interface by transmission of commands using the electrical connectors between modules. In other implementations, the base 606 may communicate with a wireless low-distance communication method such as Bluetooth or Openthread instead of directly connecting to the modules 108. The base 606 may provide power to the modules 108, control components of the modules 108 and receive the information from modules 108.

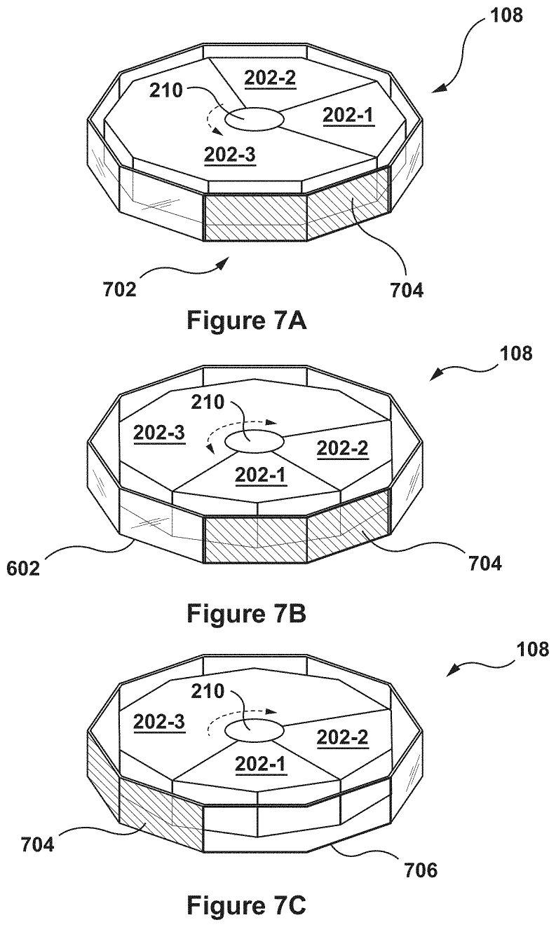

In order to control access to one or more compartments 202, the controller 112 operates an access mechanism. The module 108 has one or more access mechanisms which are operable between an open and closed position to permit a user to access salable items stored in the module 108. In some implementations, the module 108 includes one access mechanism for each compartment 202, however, it is not strictly necessary to have the same number of access mechanisms as compartments 202. In some implementations, the access mechanism is rotatable to align with a selected compartment 202, so that, when the access mechanism is opened, the user may access the selected compartment 202. The access mechanism may be rotated may be rotated by the user or by a motor controlled by the controller 112. In other examples, the access mechanism is stationary but the platform 302 is rotatable to align at least a portion of the compartment 202 with one of the access mechanisms. In some examples, one module 108 is associated with each access mechanism such that, when one of the access mechanisms is in an open position, access is granted only to the module associated with the access mechanism. In some examples, the access mechanism may further comprise a locking mechanism controlled by the internal controller in the module. The internal controller may receive a control signal from the base 606 or the computing device 124, and responsive to the control signal, operate the locking mechanism. Furthermore, the internal controller may perform some operations such as controlling lights attached on modules 108 and transferring data between modules 108. By controlling the access mechanism, the vending machine 104 can grant access to a single module or (in modules that are subdivided) a single compartment within a module. An example of an access mechanism is shown at 702 in FIGS. 7A-C, which show a perspective view of a module 108 enclosed by an enclosure 602 and having three compartments 202-1, 202-3, 202-3. The enclosure 602 comprises an access mechanism 702. In this example, the access mechanism 702 comprises a slidable door 704 and an access aperture 706, however a number of possible mechanisms are contemplated. In FIG. 7A, the access mechanism 702 is in a closed position. In this position, access to the compartments 202 through the access aperture 706 is blocked by the slidable door 704. When the controller 112 receives an input indicating a request to access the compartment 202-1, the controller 112 operates the motor to rotate the module 108, as shown in FIG. 7B. When compartment 202-1 is aligned with the access mechanism 702, the controller 112 controls the access mechanism to move the slidable door 704 from a closed position (shown in FIG. 7B) to an open position (as shown in FIG. 7C). In the open position, the slidable door 704 does not block the access aperture 706, and compartment 202-1 may be accessed through the access aperture 706. The access mechanism 702 may return to the closed position after a predetermined delay or in response to a further input at the controller 112.

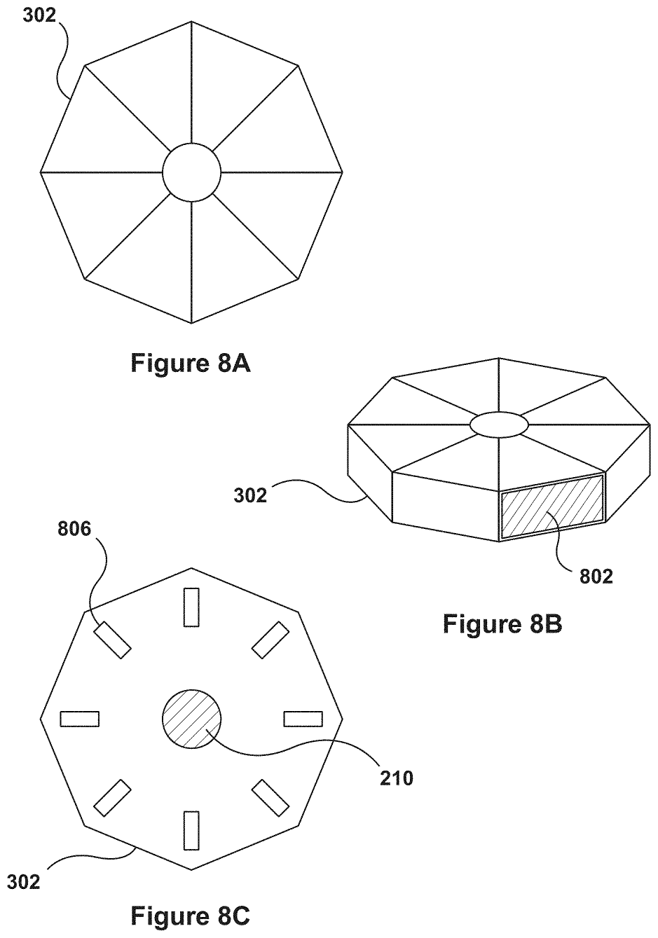

The modules 108 may be further customized to suit a vendor's needs. FIGS. 8A-C show an implementation of the platform 302 which may be connected to various accessories such as lights, sensors, audio devices, visual displays, cameras, printers, input devices, network interfaces, and the like. FIG. 8A shows a top view of the platform 302 and FIG. 8B shows a perspective view of the platform 302 connected to an accessory 802. The platform 302 may be connectable to accessories 802 via one or more connectors 806 on the lower surface of the platform (shown in FIG. 8C). The platforms 302 in a vending unit 600 may be in communication with the base 606 (shown previous in FIG. 6) in order to send signals to and receive signals from the base 606. The base 606 may be further connected to the controller 112 such that the controller 112 may send signals to and receive signals from the module 108. For example, the controller 112 may send a control signal to the module 108 to operate the access mechanism, the motor, or the accessories 802 in a module 108. In other implementations, the module 108 includes a network interface and signals are transmitted between the module 108 and the controller 112 wirelessly. In further implementations, the base 606 includes a network interface and signals are transmitted between the base 606 and the controller 112.

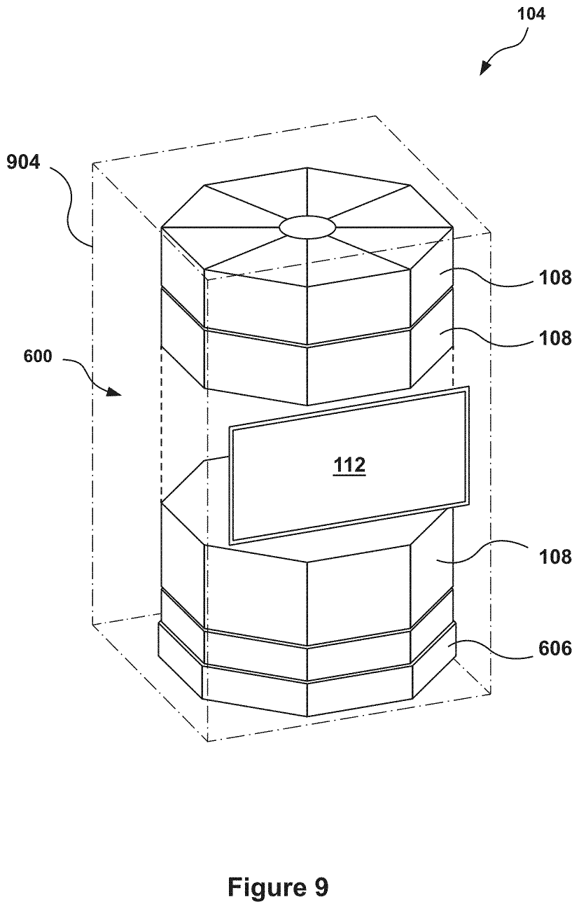

Two specific implementations of the vending machines 104 are shown in FIGS. 9 and 10. In these implementations, the vending machine 104 comprising a housing 904 for supporting the modules 108 and the controller 112. The modules 108 are octagonal prisms and configured to stack on top of each other. FIG. 9 shows an embodiment with a single vending unit 600. As seen in FIG. 10, the modules may have various sizes, chosen to accommodate items of different size. The modules 108 are further configured to stack on top of a base 606. The base 606 may be motorized such that the stack of modules 108 on top of the base 606 can be rotated. The base 606 may be programmed to rotate continually, periodically, or in response to an input received at the controller 112. The modules 108 may be enclosed and each module 108 may further include an access mechanism (not shown) having an open position and a closed position such that, when the access mechanism is in an open position, a user may access one or more items in said module 108. The access mechanism may be controlled by the controller 112 in response to an input received at the controller 112.

In the implementation shown in FIG. 10, the vending machine 104 is subdivided into vending units 600, each vending unit 600 configured to accommodate one or more modules 108. The vending unit 600 may be enclosed by a barrier and the barrier may include at least one access mechanism (not shown) having an open position and a closed position such that, when the access mechanism is in an open position, a user may access one or more items in one or more modules 108. The access mechanism may be controlled by the controller 112 which may use an internal controller in base 606 in response to an input received at the controller 112. In order to allow a customer to view the salable items, the barrier may be partially or entirely transparent. For example, the barrier may substantially comprise glass, plexiglass, polymer, or another suitable material.

In a specific implementation, the modules 108 are enclosed but neither the vending machine 104 nor the vending units 600 are enclosed. Each module 108 is enclosed by a cylindrical, transparent barrier that includes at least one sliding door for accessing the salable items in the respective module 108. The sliding door is controlled by the controller 112 in response to an input received at the controller 112.

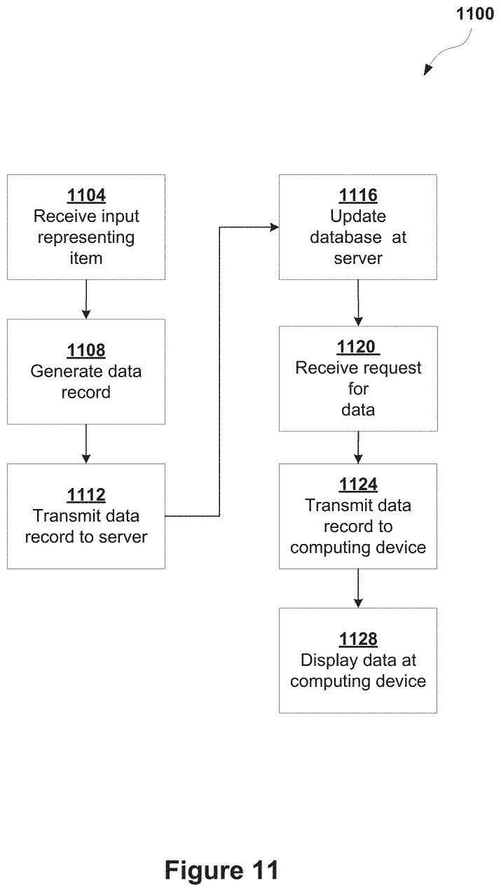

Referring now to FIG. 11, a method of managing modular vending machines is represented as a flowchart and indicated generally at 1100. In order to assist in the explanation of the method, it will be assumed that method 1100 is performed using system 100. Furthermore, the following discussion of method 1100 will lead to further understanding that system 100 and/or method 1100 can be varied and need not work exactly as discussed herein in conjunction with each other, and that such variations are within the scope of the present invention.

Block 1104 comprises receiving an input representing an update associated with one of the vending machines in the system. The update may be, for example, an update to an item status (e.g., after a sale or the like), or in the configuration (e.g., the addition or removal of a vending unit) of the vending machine, or other updates. In system 100, block 1104 is performed by controller 112, which receives the input. The input may be received by a user interface or a sensor connected to the controller 112. In implementations where the input is received by a sensor, the sensor may consist of an imaging device, load cell, motion sensor, NFC (near field communication) device, RFID (radio-frequency identification) reader, or the like, for detecting when an item has been added or removed from one of the modules 108, or when a vending unit 600 has been added or removed from one of the vending machines 104. For example, the input may comprise a status signal indicating that one or more items in the vending machine 104 have been removed by a customer or that an item has been added by the vendor. The status signal may include an item identifier for said item. In another example, the vending machine 104 includes a unit sensor for identifying a vending unit 600 installed at the vending machine 104. The unit sensor may recognize an RFID tag, barcode, or other identifiable feature on the vending unit 600 which represents the unit identifier for said vending unit 600. The unit sensor may detect when a vending unit has been added or removed from one of the vending machines 104 and sends a removal signal or installation signal to the controller 112 in response to detecting the removal or installation of a vending unit 600. The removal signal might include the unit identifier corresponding to the barcode on the vending unit 600.

Block 1108 comprises generating a data record update based on the input. The data record may comprise a status signal indicating whether an item has been added or removed from the vending unit 600, information representing characteristics of an item, an identifier associated with an item, quantities of an item, the number of sectors in a module 108, an identifier associated with the module 108, an identifier associated with the vending unit 600 and an identifier associated with the vendor selling the item, characteristics of the module 108, the location of the vending machine 104, the date the item was stocked, the purchase date, the purchase price for the item, the expiry date for the item, and the like. Updates to the configuration of a vending machine 104 by addition or removal of a vending unit 600 may result in a data record update including the machine identifier corresponding to the vending machine 104 and a unit identifier corresponding to the vending unit 600 which was added or removed. The data record may further include a removal signal indicating that the corresponding vending unit 600 has been removed from the vending machine 104 or an installation signal indicating that the corresponding vending unit 600 has been added to the vending machine 104.

In examples where the sensor comprises an imaging device, the input may comprise a video or one or more images of an item. In these examples, block 1108 may further comprise analyzing the input at a processor in the controller 112 to identify the item represented by the input. The input may be analyzed with techniques known in the art including, but not limited to, image recognition software, machine learning, image classification, and a combination thereof.

In implementations where the sensor is an RFID reader, each item sold in the vending machine may include at least one RFID tag. In these implementations, the input may comprise an identifier representing the item.

Block 1112 comprises transmitting the data record to the server 120 via the network 116. Block 1112 is performed by the controller 112 which transmits the data record using the network interface. Block 1112 may be performed periodically or in response to generating a data record based at block 1108.

Block 1116 comprises updating a database based on the data record. Block 1116 is performed by the server 120 which receives the data record via the network 116 and updates the database stored in memory at the server 120.

Block 1120 comprises receiving a request for data from the computing device 124. Block 1120 is performed by the server 120. The request may represent an input received at the computing device 124 via a user interface. The input may represent an item, a characteristic of an item, a location of a customer, a distance from a customer, a location of a vending machine 104, a quantity of an item, a vendor, a characteristic of the module 108, a date an item was stocked, a purchase date, a purchase price for an item, an expiry date for an item, or a combination thereof. As part of block 1120, the server 120 matches the request to one or more data records stored in memory at the server 120 and retrieves said data records for transmission to the computing device 124.

Block 1124 comprises transmitting one or more data records to the computing devices 124 via the network 116. Block 1120 is performed by the server 120. Block 1120 may be performed continually, periodically, in response to receiving a data record from the controller 112, or in response to receiving a request from the computing device 124.

For example, the computing device 124 may transmit a request to the server 120 for a particular item. In response, the server 120 may match the request to one or more data records corresponding to the request item and transmit said data records to the computing device 124.

In some implementations, one or more data records may be protected by security measures. The request from the computing device 124 may further include a pass key and a vendor identifier. For instance, a vendor may be given a unique pass key and vendor identifier upon registration. In order to retrieve certain data records, the request must include the correct vendor identifier and pass key. When the server 120 receives the request, the server 120 compares the pass key and vendor identifier received in the request to the pass key and vendor identifier stored in association with the requested data record. If the received pass key and vendor identifier match the stored pass key and vendor identifier, the server 120 transmits the requested data record. Otherwise, the server 120 does not transmit the request data record. The use of a pass key and vendor identifier ensures that a vendor can access data pertaining to their own products and sales, while purchasers and other vendors can only access a subset of that data.

Block 1128 comprises displaying the data record at the computing device 124. The computing device 124 may display the data at a user interface connected to the computing device 124. The data record may be displayed as text, a chart, a table, a graph, a map, or any suitable method.

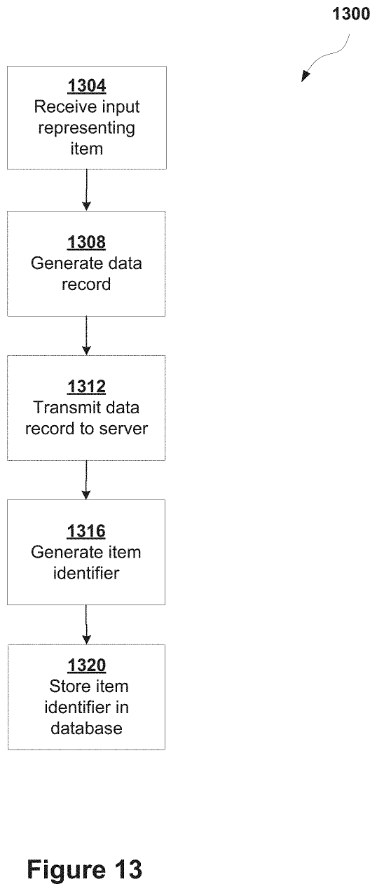

Before items can be purchased at the vending machine 104, those items must first be registered to the system 100. FIG. 13 is a flowchart depicting a method of registering items using system 100. In the example described herein, blocks 1304 to 1312 are performed by the computing device 124, but in other examples, blocks 1304 to 1312 may be performed by the controller 112. At block 1304, the computing device 124 receives in input representing an item. The input may indicate characteristics of an item such as the sales price, the quantity, the expiry date, the vendor, a textual description of the item, an RFID tag associated with the item, images of the item, and the like. At block 1308, the computing device 124 generates a data record corresponding to the input. At block 1312, the computing device 124 transmits the data record to the server 120 via the network 116. At block 1316, the server 120 generates an item identifier corresponding to the item. At block 1320, the server 120 stores the data record in association with the item identifier in memory.

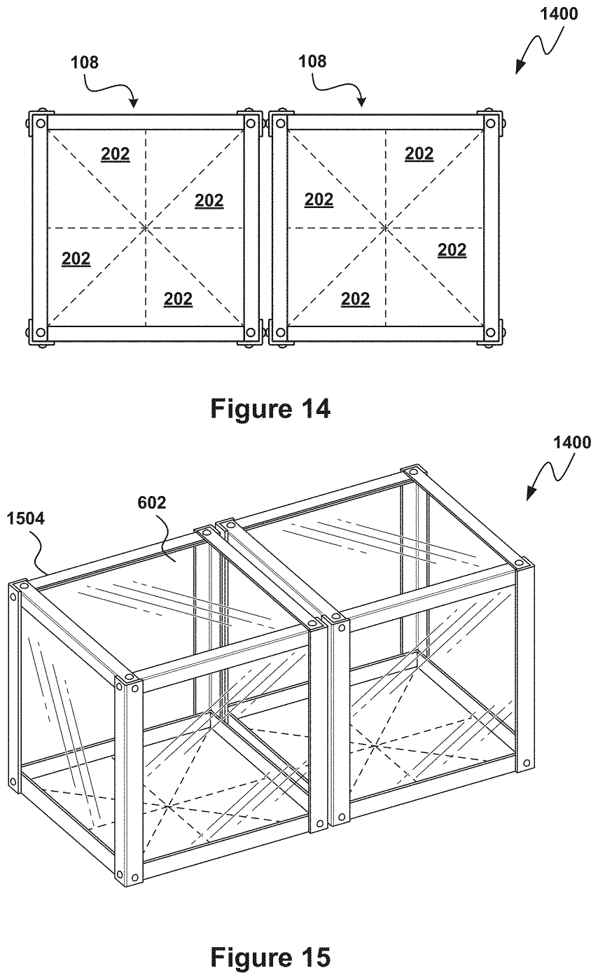

Another embodiment of the vending machine is depicted at 1400 in FIGS. 14 and 15. In this embodiment, the modules 108 are cube-shaped. As described in earlier embodiments, the enclosure 602 comprises a transparent or translucent material. In this embodiment, the enclosure further includes a frame 1504 for supporting the enclosure 602. The cube-shaped modules 108 may be stacked vertically or positioned side-by-side. Adjacent modules 108 may be joined with a connector. The modules 108 may be subdivided radially, horizontally, or vertically into a plurality of compartments 202 for storing salable items.

As will now be apparent to a person skilled in the art, the system and method may simplify the process of restocking a vending machine by automatically detecting when an item has been stocked. In implementations that include one or more sensors in the modules 108, the sensor automatically detects when an item has been added to a module and sends an input signal to the controller 112. The controller 112 generates a data record based on the input and sends the data record to the server 120. The data record may comprise an item identifier and a location of the item. The location may be expressed as the compartment 202, module 108, vending unit 600, vending machine 104, or combination thereof. In implementations without a sensor, an input comprising an item ID and location may be input at the computing device 124 or at the controller 112. The computing device 124 or controller 112 transmits the item ID and location to the server 120 for storage in the database.

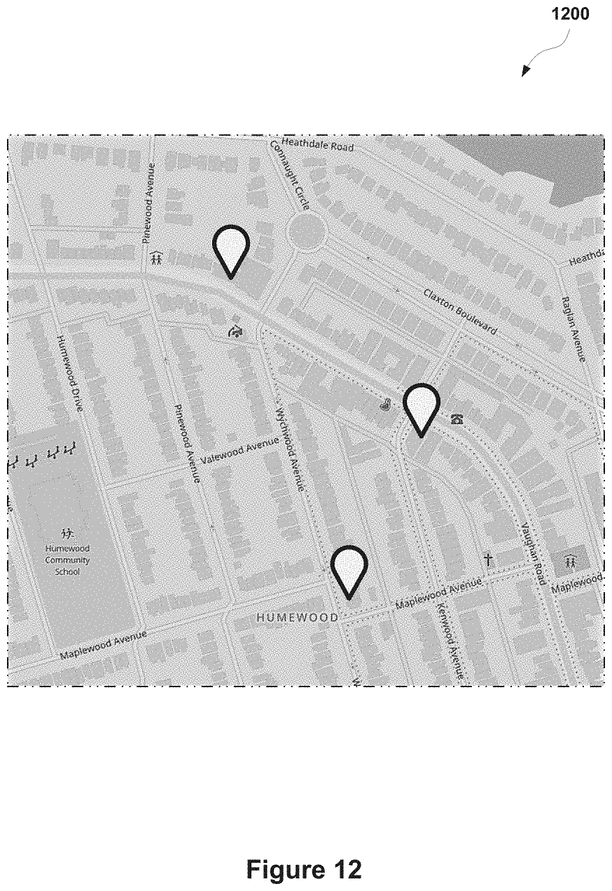

A further advantage of the system is that it enables a customer to locate a salable item from their personal computing device. In an exemplary performance of method 1100, the computing device 124 transmits a request for data representing a location and an item. The location may represent the customer's location and may be expressed as a postal code, street address, street name, city, address, geographic coordinates, a landmark, or another suitable means. The request may further include a distance from the customer's location. The item may be expressed as a textual description, an item identifier, a vendor name, a manufacturer name, or other suitable means. Upon receiving the request at block 1120, the server 120 compares the request to data records stored in the database. Each data record includes a machine identifier corresponding to a vending machine 104 and further includes location information representing the geographical location of said vending machine 104. If one or more data records in the database correspond to the request, the server 120 transmits the data record to the computing device 124 at block 1124, and the computing device 124 displays the data record at block 1128. In this example, the customer has requested a specific item within a short distance of the customer's location. As shown in FIG. 12, the data record may be displayed as a map, indicating the location(s) of one or more vending machines 104 near the customer that currently stock the requested item.

The system 100 may facilitate payments to be made through a number of different methods. In some implementations, a purchase transaction may occur between the computing device 124 associated with the customer and the server 120. When the payment provider verifies the payment, the server 120 may send a secure token to the computing device 124 and the controller 112. The customer may then enter the secure token at an input device associated with the controller 112. If the secure token entered at the input device matches the secure token sent to the controller 112 from the server, the controller 112 may control the access mechanism to grant access to the module 108 where the purchased item is stored. The input device may comprise a keyboard, pin pad, touch display, NFC reader, barcode scanner, RFID reader, QR code scanner, Bluetooth device, wireless communication device, or the like. In other implementations, the purchase transaction may occur at the controller 112. The controller 112 may receive an item identifier and a payment confirmation from an input device connected to the controller 112. In these implementations, the input device may comprise a coin acceptor or point of sale (PoS) terminal. In response to receiving the payment confirmation from the input device, the controller 112 may control the access mechanism to grant access to the module 108 where the purchased item is stored.

As previously mentioned, one or both of the modules 108 and the vending units 600 may be removably attached to the vending machine 104, which may allow a module 108 or a vending unit 600 to be relocated from one vending machine 104 to another vending machine 104 with limited inconvenience. A method of relocating the modules 108 will be described herein, however, the method may similarly apply to the vending units 600. To relocate one or more modules 108, the vendor may enter an input at the controller 112 associated with a first vending machine 104 or at the computing device 124. The input may comprise a vendor identifier and pass key. The input may further indicate the module 108 to be relocated. In response to the input, the controller 112 may transmit a control signal to the module 108 causing a locking mechanism to disengage. In other embodiments, the user disengages the locking mechanism with a mechanical key. Once the locking mechanism is disengaged, the module 108 may then be removed from the first vending machine 104. Once the module 108 has been transported to a second vending machine 104 and connected to said vending machine 104, an input received at the controller 112 or via the computing device 124 may cause the locking mechanism on the second vending machine 104 to engage. In some implementations, the controller 112 automatically senses the location of the module 108, however, in other implementations, an input received at the controller 112 or via the computing device 124 may indicate the location of the module 108. The new location of the module 108 may be transmitted to the server 120 via the network 116.

As may now be apparent to a person skilled in the art, the reconfigurable vending machine disclosed herein provides a number of benefits over the prior art. The modularity of the vending machines 104 allows vendors to share resources including the controller 112, various accessories associated with the controller 112 or base 606, and certain structural elements. Additionally, vendors may share server resources for managing stock and processing payments. This system conserves system resources while providing flexibility to vendors to relocate their modules between two or more vending machine locations.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A system for managing vending machines, the system comprising:
a plurality of vending machines including a first vending machine, the first vending machine corresponding to a machine identifier, the first vending machine comprising:
a vending unit for storing a salable item, the vending unit configured to be removably received by the first vending machine; and
a controller configured to:
obtain the machine identifier corresponding to the first vending machine;
obtain a unit identifier corresponding to the vending unit; and
transmit the unit identifier and the machine identifier via a network; and
a server configured to:
receive the unit identifier and machine identifier from the controller; and
update a data record stored in memory at the server in association with the unit identifier, the data record representing characteristics of the vending unit, the updating based on the machine identifier received from the controller.

2. The system of claim 1 wherein the controller is integrated in the first vending machine and the machine identifier is stored in memory at the controller.

3. The system of claim 1 wherein the controller is remote from the first vending machine and configured to receive an input representing the machine identifier.

4. The system of claim 3 wherein the controller is integrated in a computing device.

5. The system of claim 1 further comprising a computing device configured to request the data record from the server, wherein the server is configured to transmit the data record to the computing device in response to the request.

6. The system of claim 1 wherein the vending unit includes a barcode representing the unit identifier, and wherein the first vending machine comprises a unit sensor configured to:
detect the barcode; and
transmit a signal to the controller in response to detecting the barcode, the signal including the unit identifier.

7. The system of claim 6 wherein the unit sensor is further configured to:
detect when the vending unit has been removed from the first vending machine; and
send a removal signal to the controller in response to detecting the removal, the removal signal including the unit identifier.

8. The system of claim 1 wherein the first vending machine comprises a product sensor to detect the salable item and transmit a signal to the controller corresponding with an item identifier, the item identifier representing the salable item.

9. The system of claim 1 wherein the characteristics of the vending unit further include at least one of: a vendor identifier representing a vendor associated with the vending unit, an item identifier representing the salable item, a quantity of the salable item, a quality of the salable item, and a price of the salable item.

10. The system of claim 5 wherein the data record includes location information corresponding to the vending unit and wherein the computing device is configured to display the location information in response to receiving the data record from the server.

11. A method for managing a plurality of vending machines including a first vending machine, the method comprising:
obtaining a machine identifier corresponding to the first vending machine;
obtaining at the controller a unit identifier corresponding to a vending unit, the vending unit removably received by the first vending machine and configured to store a salable item;
transmitting the unit identifier and the machine identifier from the controller to the server via a network; and
updating a data record stored in memory at a server connected to the network, the data record stored in association with the unit identifier, the data record representing characteristics of the vending unit, the updating based on the machine identifier received from the controller.

12. The method of claim 11 further comprising transmitting the data record from the server to a computing device in response to a request from the computing device.

13. The method of claim 11 wherein the first vending machine comprises a unit sensor, the method further comprising:
detecting a barcode on the vending unit using the unit sensor, the barcode representing the unit identifier; and
transmitting a signal to the controller in response to detecting the barcode, the signal including the unit identifier.

14. The method of claim 13 further comprising:
detecting using the unit sensor when the vending unit has been removed from the first vending machine; and
sending a removal signal from the unit sensor to the controller in response to detecting the removal, the removal signal including the unit identifier.

15. The method of claim 11, wherein the plurality of vending machines further includes a second vending machine, the method further comprising:
relocating the vending unit from the first vending machine to the second vending machine, the second vending machine comprising a second controller configured to store a second machine identifier in memory, the second machine identifier corresponding with the second vending machine;
receiving at the second controller a second input representing the unit identifier; and
in response to receiving the second input, transmitting the unit identifier and the second machine identifier from the second controller to the server.

16. The method of claim 11 further comprising:
inputting at the controller an item identifier associated with the salable item;
inputting at the controller a status signal, the status signal indicating whether the salable item has been added or removed from the vending unit;
transmitting the item identifier, the status signal, and the unit identifier to the server;
retrieving the data record associated with the unit identifier, the data record including a quantity of the salable item; and
updating the quantity of the salable item based on the status signal.

17. The method of claim 11 wherein the characteristics of the vending unit further include at least one of: a vendor identifier representing a vendor associated with the vending unit, an item identifier representing the salable item, a quantity of the salable item, a quality of the salable item, and a price of the salable item.

18. The method of claim 12 wherein the data record includes location information corresponding to the vending unit, the method further comprising displaying the location information at the computing device in response to receiving the data record from the server.
